(19) United States
(12) Patent Application Publication
(10) Pub. No.: US 2004/0117324 A1
(43) Pub. Date: Jun. 17, 2004

(54) System and method for automated registration of image producing devices

(76) Inventors: Jeffry R. Huelse, Eagle, ID (US); Janel Johnson, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/316,492

(22) Filed: Dec. 11, 2002

(51) Int. Cl. G06F 17/60

(52) U.S. Cl. 705/401

(57) ABSTRACT

A system and method for automated registration fulfillment for image producing devices is disclosed comprising a fulfillment application disposed on the image producing device, a trigger application for executing the fulfillment application on an initial start up of the image producing device, and a database of device identification information on the image producing device, wherein, on execution, the fulfillment application uses the device identification information to complete a registration document.

### CROSS-REFERENCE TO RELATED APPLICATIONS

The present application is related to commonly assigned, co-pending U.S. patent application Ser. No. 09/848,695, filed May 3, 2001, entitled, “PROVIDING AUTOMATED WARRANTY FULFILLMENT FUNCTIONALITY FROM A CONSUMABLE;” and U.S. patent application Ser. No. 09/848,634, filed May 3, 2001, entitled, “PROVIDING USER-ACCESSIBLE INFORMATION FROM A CONSUMABLE, the disclosures of which are hereby incorporated herein by reference.

### FIELD OF THE INVENTION

The present application relates in general to image producing devices, and more particularly, to a system and method for providing automated registration of image producing devices.

### DESCRIPTION OF RELATED ART

Image producing devices, such as printers, fax machines, copiers, multifunction devices, and the like, are proliferating throughout both the commercial and home consumer markets as the costs for these devices come down. Many of the improvements that have occurred in these image producing devices over the last decade have come from consumer feedback and manufacturers' analyses of failed devices through the warranty fulfillment process. One factor to the continued success of image producing device development lies in the continued participation in the warranty fulfillment process.

In today's market, most image producing devices are packaged in a box with the familiar foam padding and a package of documents that contain various numbers of advertisements, instruction booklets, quick-start instruction booklets, catalogs of related products, warranty cards, and the like. Considering the amount of dross included in the documentation typically accompanying hardware devices, many warranty cards end up thrown away. Each warranty card that fails to make it back to the manufacturer represents a failed opportunity to study and improve the devices. Furthermore, some companies require the warranty card to be returned as a condition to honoring the warranty.

In an effort to increase the number of warranty cards returned, some manufacturers have placed pre-printed adhesive labels onto the cards containing part of the necessary information, such as the hardware model or serial number. This reduces the work that a consumer will have to do in completing and mailing the warranty card. However, consumers generally must still fill out the personal and any other desired information, if they can even find the warranty card in the first place or have not disposed of it either accidentally or purposefully.

### BRIEF SUMMARY OF THE INVENTION

Embodiments are directed to an automated registration fulfillment system for image producing devices, the system comprising a fulfillment application disposed on the image producing device, a trigger application for executing the fulfillment application on an initial start up of the image producing device, and a database of device identification information on the image producing device, wherein, on execution, the fulfillment application uses the device identification information to complete a registration document.

Additional embodiments are directed to a method for automatically generating fulfillment information comprising detecting a first time activation of a print-capable device, executing a registration application on the print-capable device in response to the detecting, retrieving identification information from a management information base (MIB) associated with the print-capable device, and inserting the retrieved identification information into a form stored on a memory located on the print-capable device.

Additional embodiments are directed to a computer program product having a computer readable medium with computer program logic recorded thereon, the computer program product comprising code for detecting a first time start-up of a printing device, code for triggering a registration fulfillment program on the printing device in response to the code for detecting, code for obtaining registration information from a management information base (MIB) associated with the printing device, and code for inserting said obtained registration information into a registration document stored on a memory on the printing device.

### BRIEF DESCRIPTION OF THE DRAWINGS

FIG. 1 is a block diagram illustrating a system including an image producing device configured according to one embodiment of the registration system described herein;

FIG. 2 is a block diagram detailing the processing module as found in the image producing device of FIG. 1 according to one embodiment of the present invention;

FIG. 3 is a block diagram illustrating a system including an additional embodiment of the automated registration system described herein;

FIG. 4 is a flowchart illustrating an embodiment of the automated registration process described herein;

FIG. 5A is a diagram illustrating a first side of a warranty form that has been printed using the teachings of representative embodiments of the registration fulfillment system described herein; and

FIG. 5B is a diagram illustrating a second side of a warranty form that has been printed using the teachings of representative embodiments of the registration fulfillment system described herein.

### DETAILED DESCRIPTION

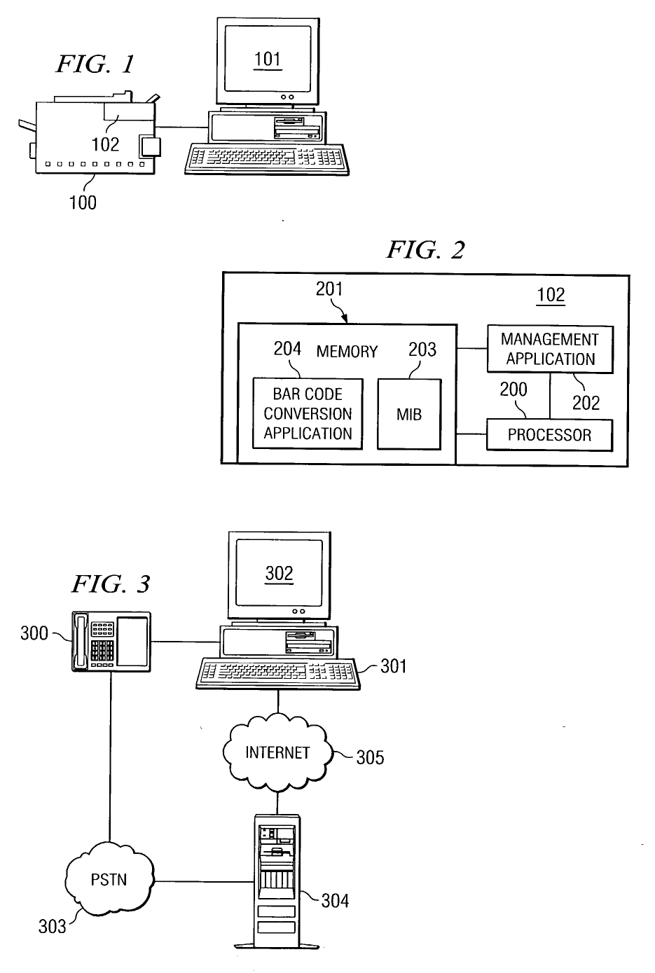

FIG. 1 is a block diagram illustrating image producing device 100 configured according to one embodiment of the registration system described herein. While image producing device 100 is illustrated as a multifunction printer/fax/copier, it should be noted that any such type of device may be configured similarly. In setting up image producing device 100, a user may connect it to personal computer (PC) 101. When the user initially starts up image producing device 100, a triggering application located in image producing device 100 monitors the first time activation and signals computer code within processing module 102 to run a fulfillment/registration application or program to automatically generate a fulfillment or registration document or form, such as may be used for warranty registration, that fills in device identification information, such as the printer model, serial number, firmware version, and other such registration and warranty information. The triggering application may also be located within processing module 102. The registration form may be printed as part of a test page or may be printed in addition to, or alternatively to a test page.

Once the pre-filled registration document has been printed out, the user typically only needs to fill in any personal information and answer any other demographic or other type of questions asked. Alternatively, personal information may automatically be retrieved from PC 101 when that information has been entered by a user. The user may then mail or fax the completed registration document to the manufacturer, warranty issuer, or the like. Because image producing device 100 automatically prints out the registration document at first start up, the user's attention is drawn to the importance of the registration fulfillment process. The user is no longer required to search through the vast documentation that typically accompanies hardware.

FIG. 2 is a block diagram detailing processing module 102 as found in image producing device 100 of FIG. 1 according to one embodiment of the present invention. Processing module 102 of the illustrated embodiment includes processor 200 that performs the processing of the software that controls the image producing processes as well as the communications between image producing device 100 and PC 101 (FIG. 1). Processing module 102 also includes memory 201 for storing firmware, fonts, management information base (MIB) 203, and the like. Management application 202 is the software/firmware application that manages the operations of image producing device 100. Management application 202, which may be located in memory 201, includes monitoring or triggering code that recognizes the first start up of image producing device 100 (FIG. 1). When the initial start up state is triggered, management application 202 signals processor 200 to run a fulfillment or registration application or program that will print a form registration document as stored in memory 201. Management application 202 also instructs processor 200 to fill the device identification information found in MIB 203, or database of identification information into the appropriated spaces in the registration document. Once the identification information has been successfully incorporated into the registration form or document, processor 200 may print the completed registration document from image producing device 100 (FIG. 1). Processor 200 may also cause a completed version of the registration document to be saved in memory 201.

FIG. 3 is a block diagram illustrating an additional embodiment of the automated registration system described herein. Fax machine 300 is configured according to the teachings of the described additional embodiment. It should be noted, however, that although a fax machine is discussed with respect to the embodiment shown in FIG. 3, other printing type devices may be used with various embodiments as described herein. In one configuration, fax machine 300 may be connected to PC 301. When fax machine 300 is initially activated, a registration fulfillment program is triggered that starts an interactive registration process with the user on computer display 302 of PC 301. An electronic version of the registration document is displayed on computer display 302 with interactive menus and/or dialog boxes prompt or cue the user to enter requested information through a graphical user interface (GUI) on computer display 302. The user, in interacting with these menus and/or dialog boxes on the GUI, fills in the user's personal information and any demographic information and/or additional information that the user desires to give. When the user has finished entering all of the information, fax machine 300 may print out the warranty information that includes all of the user-entered information and all of the device identification information that is automatically retrieved from MIB 203 (FIG. 2) in the memory of fax machine 300. Alternatively, the additional information may automatically be retrieved from PC 301. The user need only then send the completed warranty registration document to the manufacturer or other entity.

In an optional configuration, the fulfillment application may, instead, direct fax machine 300 to fax the completed registration document to collection server 304 over publicly switched telephone network (PSTN) 303. Collection server 304 may be operated by the manufacturer, or other party interested in such registration information, or may be operated by an outsourcing company that the manufacturer has contracted with to assist with the fulfillment process. In this optional configuration, fax machine 300 may be connected to PC 301 or may stand alone. If fax machine 300 stands alone, the warranty fulfillment application may run and provide user interaction with a display on fax machine 300.

In still another optional configuration, during the interaction with the user, the fulfillment application may detect or ask if the user has an Internet or other suitable data network connection. Instead of faxing or printing out the completed registration document, the application sends the completed document electronically to collection server 304 via Internet 305. These different optional configurations may all be provided in a particular fulfillment application on an image producing device. In such circumstances, an option may be presented to the user to select the delivery method desired by the user. For example, PC 301 may provide a communication interface, such as a network interface to a data network, like the Internet. The registration fulfillment program may then prompt the user to select submitting the registration form using a fax capability, through some kind of fax interface, or an electronic communication capability, through some kind of electronic communication interface that provides email or other such electronic communication formats. These communication formats may be provided either on PC 301 or could be provided on the printing device.

An additional option that may be added to the different embodiments of the automated fulfillment process described herein is a prepaid indicia of postage or the business reply information. The U.S. Postal Service, in addition to several approved private companies, may now provide electronic postage. Electronic stamps may now be purchased over the Internet that may be printed on envelopes or postcards directly from a user's computer. Leveraging this technology may allow a manufacturer of print-capable devices to either store or download an indicia of postage from an electronic postage vendor that may be printed by the image producing device onto the warranty/registration form or warranty registration document at printing time. This would relieve the consumer of paying for or providing a stamp or other postage for mailing a printed warranty document.

In these optional configurations, the user has very few steps to complete. This reduction in the number of overt steps generally increases the likelihood that the user will actually complete the automated fulfillment process and also increases the accuracy of the information. Additionally, because the fulfillment application of various embodiments runs interactively on PC 301 or directly on fax machine 300, the user may perceive that the registration process is important and should be completed.

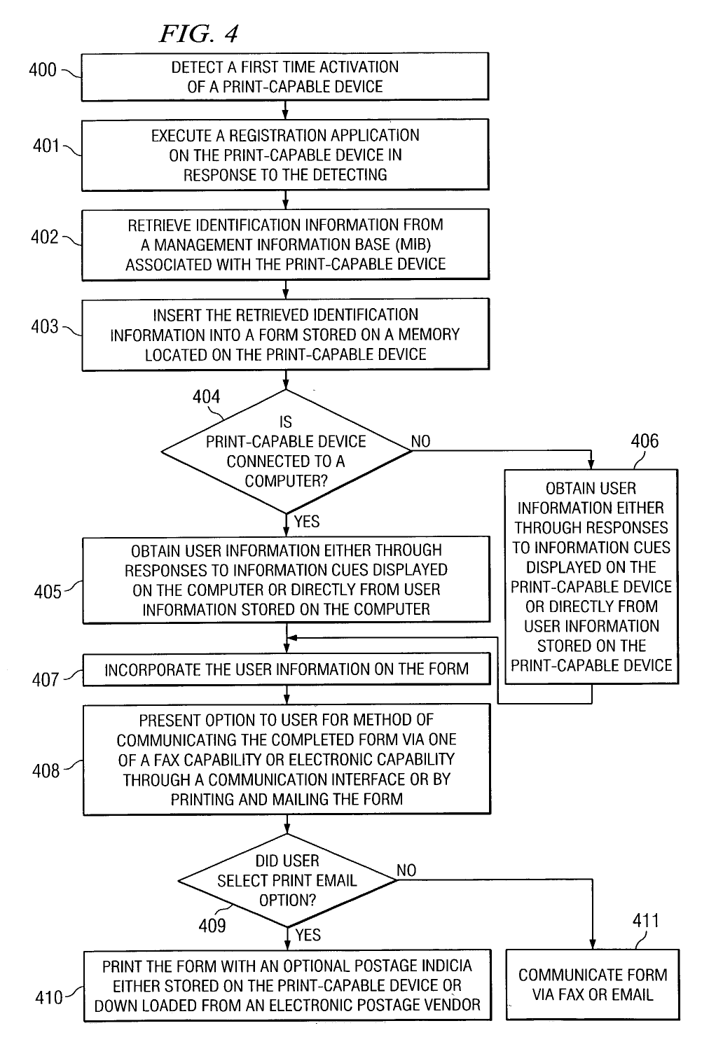

FIG. 4 is a flowchart illustrating an embodiment of the automated registration process described herein. In step 400, a first time activation of a print-capable device is detected. In step 401, a registration application is executed on the print-capable device in response to the detecting. Identification information is retrieved from a management information base (MIB) associated with the print-capable device in step 402. In step 403, the retrieved identification information is inserted into a form stored on a memory located on the print-capable device. In optional embodiments, the print-capable device may be connected to a computer. A determination is made in step 404 as to whether a computer is connected or not. If a computer is connected, information cues may be displayed to a user on the computer or the user information may be taken directly from a memory on the computer in step 405. Alternatively, if no computer is connected, the user information may be obtained by interacting with the user with information cues directly on the print-capable device or directly taken from a memory on the print-capable device in step 406. The user input may then be incorporated on the form in step 407. In step 408, options may be presented to the user to determine whether the form will be communicated with a communication interface using either a fax capability or an electronic communication capability, where the communication interface is disposed on either the print-capable device or the computer or whether the form will be printed and mailed by the user. In step 409, a determination is made as to whether the user selected to print and mail the form. If so, the form is printed in step 410 and may optionally include printing an indicia of postage on the form, wherein the indicia of postage is either originally stored on the memory or downloaded from an electronic postage vendor. If the user does not select to print out the form, the completed form is communicated in step 411 according to the user's selection via either fax or electronic mail to the interested party.

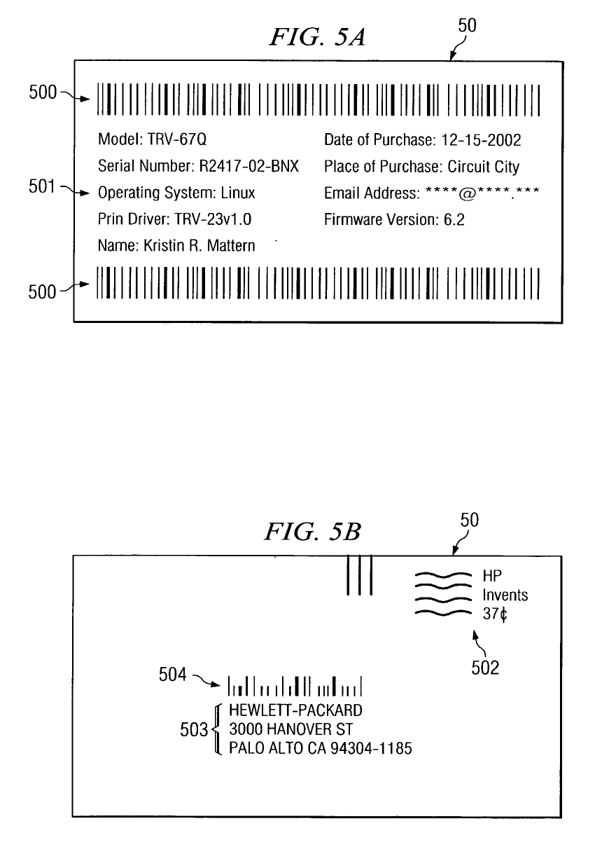

FIG. 5A is a diagram illustrating a first side of warranty form 50 that has been printed using the teachings of representative embodiments of the registration fulfillment system described herein. In additional representative embodiments, the device identification information and the other information provided by the user may be printed on one side of warranty form 50. As shown in FIG. 5A, the combined information may be printed as bar code information 500 and text information 501. Alternative embodiments may employ any different combination of bar code and text methods from supplying all of the information in a machine-readable format, such as a bar code, to supplying all of the information in a text format. The information may be converted from text or an electronic storage format to a bar code through bar code conversion application 204 (FIG. 2).

FIG. 5B is a diagram illustrating a second side of warranty form 50 that has been printed using the teachings of representative embodiments of the registration fulfillment system described herein. The registration fulfillment system as described herein may print postage indicia 502 in addition to address 503 of the warranty issuer on warranty form 50. In optional configurations, postal code 504 may also be printed to increase the postal delivery efficiency.

What is claimed is:

1. An automated registration fulfillment system for image producing devices, said system comprising:
a fulfillment application disposed on said image producing device;
a trigger application for executing said fulfillment application on an initial start up of said image producing device; and
a database of device identification information on said image producing device, wherein, on execution, said fulfillment application uses said device identification information to complete a registration document.

2. The automated registration fulfillment system of claim 1 further comprising:
a computer in communication with said image producing device, wherein said fulfillment application executes prompts for information from a user; and
a graphical user interface (GUI) on said computer, wherein said user provides information responsive to said prompts using said GUI.

3. The automated registration fulfillment system of claim 2 further comprising:
a network interface connecting said computer to a data network, wherein said completed registration document is communicated electronically to an interested party over said data network.

4. The automated registration fulfillment system of claim 2 further comprising:
a fax interface, wherein said completed warranty registration document is faxed to a warranty issuer; and
wherein said fax interface is disposed on one of:
said image producing device; and
said computer.

5. The automated registration fulfillment system of claim 1 wherein said registration document may be a warranty document.

6. The automated registration fulfillment system of claim 2 further comprising:
a bar code converter for converting said device identification information and said user provided information into a machine-readable format to be printed on said registration document.

7. The automated registration fulfillment system of claim 1 further comprising:
a network interface connecting said image producing device to a data network, wherein said completed registration document is communicated electronically to an interested party over said data network.

8. The automated registration fulfillment system of claim 1 further comprising:
a fax interface disposed on said image producing device, wherein said completed registration document is faxed to an interested party.

9. The automated registration fulfillment system of claim 1 wherein said image producing device prints a copy of said completed registration document.

10. The automated registration fulfillment system of claim 9 further comprising:
a prepaid indicia of postage stored on said image producing device, wherein said prepaid indicia of postage is automatically printed on said copy.

11. A method for automatically generating fulfillment information comprising:
detecting a first time activation of a print-capable device;
executing a registration application on said print-capable device in response to said detecting;
retrieving identification information from a management information base (MIB) associated with said print-capable device; and
inserting said retrieved identification information into a form stored on a memory located on said print-capable device.

12. The method of claim 11 further comprising:
connecting said print-capable device to a computer;
obtaining user information from said computer; and
incorporating said user information on said form.

13. The method of claim 12 wherein said user information is obtained from one of:
user input made in response to information cues displayed to a user on said computer; and
a memory on said computer containing said user information.

14. The method of claim 12 further comprising:
communicating said form with a communication interface using one of:
a fax capability; and
an electronic communication capability;
said communication interface disposed on one of:
said print-capable device; and
said computer.

15. The method of claim 12 further comprising:
converting said identification information into a machine-readable format;
converting said user information into said machine-readable format; and
printing said machine-readable identification information and said machine-readable user input on said form.

16. The method of claim 11 further comprising:
communicating said form with a communication interface using one of:
a fax capability; and
an electronic communication capability.

17. The method of claim 11 further comprising:
printing said form.

18. The method of claim 17 further comprising:
printing an indicia of postage on said form, wherein said indicia of postage is one of:
originally stored on said memory; and
downloaded from an electronic postage vendor, when said print-capable device is connectable to an Internet.

19. The method of claim 11 further comprising:
using said form to complete a warranty registration process.

20. A computer program product having a computer readable medium with computer program logic recorded thereon, said computer program product comprising:
code for detecting a first time start-up of a printing device;
code for triggering a registration fulfillment program on said printing device in response to said code for detecting;
code for obtaining registration information from a management information base (MIB) associated with said printing device; and
code for inserting said obtained registration information into a registration document stored on a memory on said printing device.

21. The computer program product of claim 20 further comprising:
code for facilitating communication between said printing device and a computer;
code for receiving said information from said computer; and
code for incorporating said information on said registration document.

22. The computer program product of claim 21 further comprising:
code responsive to said registration fulfillment program for prompting a user on said computer to enter said information.

23. The computer program product of claim 21 further comprising:
code for communicating said registration document with a communication interface using one of:
a fax interface; and
an electronic communication interface;
said communication interface located on one of:
said printing device; and
said computer.

24. The computer program product of claim 21 further comprising:
code for converting said registration information into a machine-readable format;
code for converting said user-entered information into a machine-readable format; and
code for printing said registration document using said machine-readable format.

25. The computer program product of claim 20 further comprising:
code for communicating said registration document with a communication interface using one of:
a fax interface; and
an electronic communication interface.

26. The computer program product of claim 20 further comprising:
code for printing said registration document.

27. The computer program product of claim 26 further comprising:
code for printing postage on said registration document, wherein said postage is one of:
originally stored on said memory; and
downloaded from an electronic postage vendor, when said printing device is connectable to an Internet.
